(19) United States
(12) Patent Application Publication
(10) Pub. No.: US 2013/0169912 A1
(43) Pub. Date: Jul. 4, 2013

(54) MULTILAYER FILM AND LIQUID CRYSTAL DISPLAY DEVICE

(71) Applicants: Hitoshi Ooishi, Tokyo (JP); Hiroshi Yakabe, Tokyo (JP)

(72) Inventors: Hitoshi Ooishi, Tokyo (JP); Hiroshi Yakabe, Tokyo (JP)

(73) Assignee: ZEON CORPORATION, Tokyo (JP)

(21) Appl. No.: 13/821,881

(22) PCT Filed: Aug. 19, 2011
(86) PCT No.: PCT/JP2011/068799

§ 371 Date: Mar. 8, 2013

(30) Foreign Application Priority Data
Sep. 10, 2010 (JP) 2010-203517

(51) Int. Cl. G02F 1/1333; G02F 1/1335

(52) U.S. Cl. CPC G02F 1/133305; G02F 1/133528
USPC 349/96; 428/216

(57) ABSTRACT

A multilayer film including: a substrate consisting of a resin that contains a polymer having an alicyclic structure, the substrate having a thickness of not more than 45 μm; and a resin layer provided on at least one surface of the substrate, the resin layer being formed by curing by irradiation of an active energy ray, wherein: a ratio of the substrate thickness relative to the total of the substrate thickness and the resin thickness is not less than 0.6 and not more than 0.95, and in a temperature range of not less than 30° C. and not more than 90° C., a linear expansion coefficient of the multilayer film is smaller than a linear expansion coefficient of the substrate by 5 ppm/° C. or more.

### FIELD

The present invention relates to a multilayer film and a liquid crystal display device having the same.

### BACKGROUND

An optical film that is provided in, e.g., a liquid crystal display device can be heated by, e.g., heat generated from a light source, and changes of the environment in which a liquid crystal display device is used. The heated optical film is usually subjected to deformation due to thermal expansion, or subjected to change in optical properties. Such deformation or change in optical properties tends to deteriorate display quality of a liquid crystal display device. Therefore, there has been developed a technology for suppressing thermal expansion and minimizing a linear expansion coefficient (see Patent Literature 1).

### CITATION LIST

### Patent Literature

Patent Literature 1: Japanese Patent Application Laid-Open No. 2008-231386 A.

### SUMMARY

### Technical Problem

As one of the typical display systems in a three-dimensional image display device which has been developed in recent years, there is a system called a passive system. In a passive-type three-dimensional image display device an image for a right eve and an image for a left eye are usually simultaneously displayed on the same screen, and these images are distributed in a divided manner to each of the right and left eyes through glasses for exclusive use. For this reason, the passive-type three-dimensional image display device may be equipped with a patterned phase difference film so that each of the images corresponding to each of the left and right eyes is displayed in a different polarization state at a different position. In the patterned phase difference film, different phase differences are given to respective in-plane positions in conformity with the pattern.

The patterned phase difference film is produced by, e.g., providing a layer having a desired phase difference onto a surface of a substrate film. However, if the substrate film is subjected to thermal expansion during the use of a three-dimensional image display device, the position of the phase difference film pattern may be displaced. Also, another layer which is bonded to the substrate film may be subjected to a force by thermal expansion, which may cause deformation. The deformation may lead to deterioration of image quality. In particular, when thermal expansion occurred in the in-plane direction of the film (that is, a direction orthogonal to a thickness direction of the film), deterioration of image quality was significant. Under such a circumstance, an optical film which has better ability to suppress thermal expansion than prior art is desired.

The present invention has been devised in view of the aforementioned problems. An object of the present invention is to provide a multilayer film in which a thermal expansion coefficient in an in-plane direction is suppressed in a temperature range of the usual high temperature environment in an image display device (usually, in a range of 30° C. to 90° C.), and a liquid crystal display device having the same.

### Solution to Problem

The inventors have conducted an extensive research to solve the aforementioned problems. As a result, they have found out that a linear expansion coefficient of a substrate can be effectively suppressed by providing a resin layer which is formed by curing by irradiation of an active energy ray on at least one surface of the substrate, and by setting a thickness ratio between the substrate and the resin layer to be in a predetermined range. Thus, the present invention has been completed.

That is, according to the present invention, the following (1) to (5) are provided.

(1) A multilayer film comprising: a substrate consisting of a resin that contains a polymer having an alicyclic structure, the substrate having a thickness of not more than 45 μm; and a resin layer provided on at least one surface of the substrate, the resin layer being formed by curing by irradiation of an active energy ray, wherein:

a ratio of the substrate thickness relative to the total of the substrate thickness and the resin thickness is not less than 0.6 and not more than 0.95, and

in a temperature range of not less than 30° C. and not more than 90° C., a linear expansion coefficient of the multilayer film is smaller than a linear expansion coefficient of the substrate by 5 ppm/° C. or more.

(2) The multilayer film according to (1), wherein a glass transition temperature of the resin that contains the polymer having the alicyclic structure is not less than 130° C.

(3) The multilayer film according to (1) or (2), wherein a moisture permeability of the multilayer film is not less than 20 g/m²·24 h and not more than 500 g/m²·24 h.

(4) The multilayer film according to any one of (1) to (3), wherein the resin layer formed by curing by irradiation of an active energy ray is a resin layer formed by curing a composition containing at least a component (A) and a component (B), wherein:

the component (A) is at least one type of oligomer-type acrylate selected from the group consisting of urethane acrylate, epoxy acrylate, and polyester acrylate, and

the component (B) is inorganic particles having a number mean particle diameter of 100 nm or less.

(5) A liquid crystal display device comprising a liquid crystal cell, a viewing-side polarizing plate provided at a position closer to a viewing side than the liquid crystal cell, and the multilayer film according to any one of (1) to (4) provided at a position closer to a viewing side than the viewing-side polarizing plate.

### Advantageous Effects of Invention

The multilayer film of the present invention can suppress a thermal expansion coefficient in an in-plane direction, in a temperature range when used in an image display device.

The liquid crystal display device of the present invention can prevent deterioration of image quality due to thermal expansion of a multilayer film when used.

### BRIEF DESCRIPTION OF DRAWINGS

FIG. 1 is a cross sectional view schematically showing a multilayer film according to one embodiment of the present invention.

FIG. 2 is a diagram schematically showing a structure of a three-dimensional image display device as a first embodiment of a liquid crystal display device of the present invention.

FIG. 3 is a perspective view schematically showing a liquid crystal panel, a first phase difference film, and a second phase difference film of a disassembled three-dimensional image display device, in order to explain a mechanism of image displaying in the three-dimensional image display device as the first embodiment of a liquid crystal display device of the present invention.

FIG. 4 is a diagram schematically showing a structure of the three-dimensional image display device as a second embodiment of the liquid crystal display device of the present invention.

FIG. 5 is a perspective view schematically showing a liquid crystal panel and a phase difference film of a disassembled three-dimensional image display device, in order to explain a mechanism of image displaying in the three-dimensional image display device as the second embodiment of the liquid crystal display device of the present invention.

### DESCRIPTION OF EMBODIMENTS

Although the present invention will be described in detail referring to embodiments and examples, the present invention shall not be limited to the following embodiments and examples, and can be embodied with arbitrary modifications without departing from the scope of the claims and equivalents thereof. In the following description, the term “(meth)acrylate” means “acrylate” and “methacrylate”, and “(meth)acryl” means “acryl” and “methacryl.”

[1. Multilayer Film]

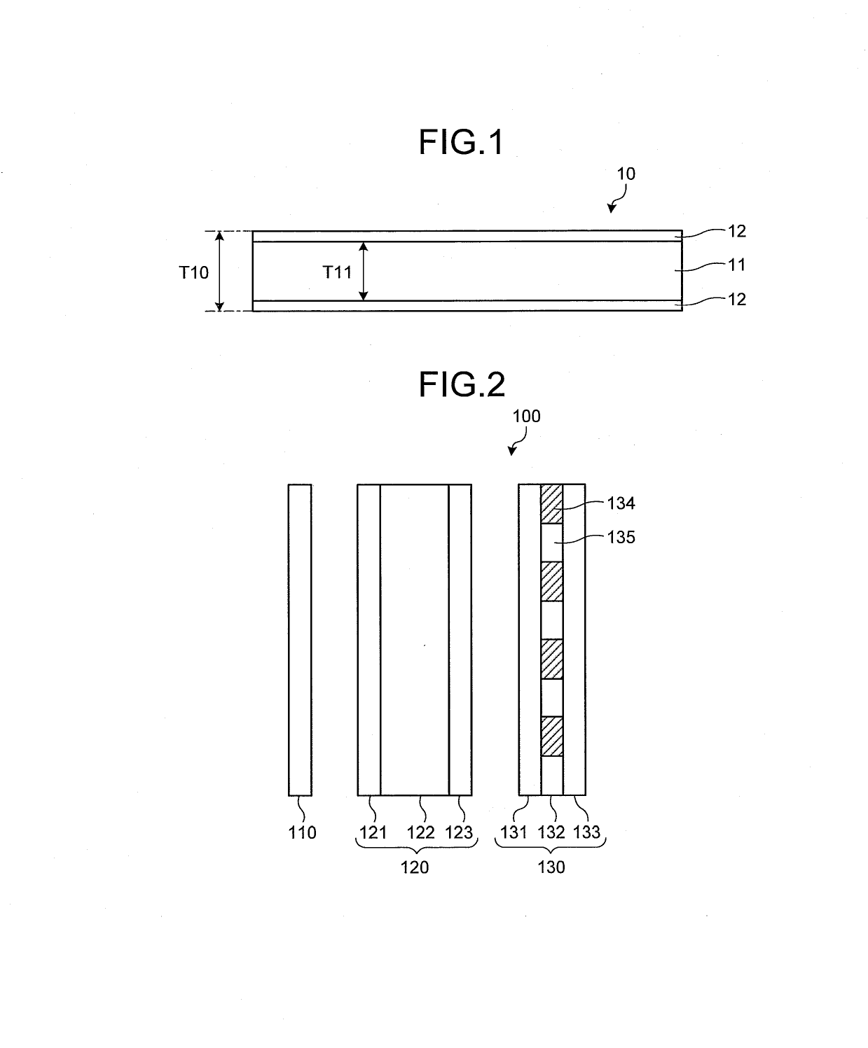

FIG. 1 is a cross sectional view schematically showing a multilayer film according to one embodiment of the present invention. As shown in FIG. 1, a multilayer film 10 of the present invention includes a substrate 11 and a resin layer (appropriately referred to hereinbelow as “cured resin layer”) 12 provided on a surface of the substrate 11. The resin layer 12 is formed by curing by irradiation of an active energy ray. Since the cured resin layer 12 thereby suppresses thermal expansion of the substrate 11, a linear expansion coefficient of the entire multilayer film 10 can be reduced.

[1-1. Substrate]

The substrate is a member consisting of a resin that contains a polymer having an alicyclic structure. The resin that contains a polymer having an alicyclic structure is a material which is excellent in, e.g., transparency, low moisture absorbance, size stability, and lightweight property, and is suitable for an optical film.

The polymer having an alicyclic structure is a polymer having an alicyclic structure in either one or both of its main chain and its side chain. Among them, in view of, e.g., mechanical strength and thermal resistance, a polymer containing an alicyclic structure in a main chain is preferable.

Examples of the alicyclic structure may include a saturated alicyclic hydrocarbon (cycloalkane) structure, and an unsaturated alicyclic hydrocarbon (cycloalkene) structure. In view of, e.g., mechanical strength and thermal resistance, the cycloalkane structure is preferable.

The number of the carbon atoms constituting the alicyclic structure is not particularly limited. However, it is preferable that the number is usually not less than 4, and preferably not less than 5, and is usually not more than 30, preferably not more than 20, and more preferably not more than 15, since thereby the characteristics of mechanical strength, thermal resistance, and substrate molding property are highly balanced.

The ratio of the repeating unit having an alicyclic structure in the polymer having an alicyclic structure is preferably not less than 55 wt %, more preferably not less than 70 wt %, and particularly preferably 90 wt %, and usually not more than 100 wt %. It is preferable that the ratio of the repeating unit having an alicyclic structure in the polymer having an alicyclic structure falls within the aforementioned range, in view of transparency and thermal resistance.

Examples of the polymer having an alicyclic structure may include a norbornene-based polymer, a monocyclic olefin-based polymer, a cyclic conjugated diene-based polymer, a vinyl alicyclic hydrocarbon-based polymer, and hydrides thereof. Among them, the norbornene-based polymer may be suitably used because of its excellent transparency and molding property.

Examples of the norbornene-based polymer may include a ring-opening polymer of a monomer having a norbornene structure, a ring-opening copolymer of a monomer having a norbornene structure and another monomer, and hydrides thereof; and an addition polymer of a monomer having a norbornene structure, an addition copolymer of a monomer having a norbornene structure and another monomer, and hydrides thereof. Among them, the ring-opening (co)polymer hydride of a monomer having a norbornene structure may be particularly suitably used in view of, e.g., transparency, molding property, thermal resistance, low moisture absorbance, size stability, and lightweight property. The “(co)polymer-” means polymer- and copolymer-.

Examples of the monomer having a norbornene structure may include bicyclo[2.2.1]hept-2-ene (trivial name: norbornene), tricyclo[4.3.0.1^{2,5}]deca-3,7-diene (trivial name: dicyclopentadiene), 7,8-benzotricyclo[4.3.0.1^{2,5}]deca-3-ene (trivial name: methanotetrahydrofluorene), tetracyclo[4.4.0.1^{2,5}.1^{7,10}]dodeca-3-ene (trivial name: tetracyclododecene), and derivatives of these compounds (for example, those having a substituent on the ring). As the monomer having a norbornene structure, one species thereof may be used alone, or two or more species thereof may be used in combination at any ratio.

Examples of the substituents that the monomer having a norbornene structure has may include an alkyl group, an alkylene group, and a polar group. The number of species of these substituents may be one, or two or more. Furthermore, the number of substituents on one monomer may be one, or two or more. Examples of the types of the polar group may include a heteroatom, and an atom group having a heteroatom. Examples of the heteroatom may include an oxygen atom, a nitrogen atom, a sulfur atom, a silicon atom, and halogen atoms. Specific examples of the polar group may include a carboxyl group, a carbonyloxycarbonyl group, an epoxy group, a hydroxyl group, an oxy group, an ester group, a silanol group, a silyl group, an amino group, a nitrile group, and a sulfone group. In order to obtain a multilayer film having low moisture permeability, it is preferable that the monomer has fewer polar group, and it is more preferable that the monomer does not have the polar group.

Examples of the monomer which can be ring-opening copolymerized with the monomer having a norbornene structure may include mono-cyclic olefins such as cyclohexene, cycloheptene and cyclooctene, and derivatives thereof; and cyclic conjugated diene such as cyclohexadiene and cycloheptadiene, and derivatives thereof. As the ring-opening copolymerizable monomer, one species thereof may be used alone, or two or more species thereof may be used in combination at any ratio.

The ring-opening polymer of the monomer having a norbornene structure, and the ring-opening copolymer of the monomer having a norbornene structure and a monomer copolymerizable therewith may be obtained by, e.g., (co)polymerizing the monomers in the presence of a publicly known ring-opening polymerization catalyst.

Examples of the monomer that can be addition copolymerized with a monomer having a norbornene structure may include an α-olefin having 2 to 20 carbon atoms such as ethylene, propylene and 1-butene, and derivatives thereof; cycloolefin such as cyclobutene, cyclopentene and cyclohexene, and derivatives thereof; and non-conjugated diene such as 1,4-hexadiene, 4-methyl-1,4-hexadiene, and 5-methyl-1,4-hexadiene. Among them, α-olefin is preferable, and ethylene is more preferable. As the addition copolymerizable monomer, one species thereof may be used alone, or two or more species thereof may be used in combination at any ratio.

The addition polymer of the monomer having a norbornene structure, and the addition copolymer of the monomer having a norbornene structure with a monomer copolymerizable therewith may be obtained by, e.g., polymerizing the monomers in the presence of a publicly known addition polymerization catalyst.

When a hydride such as a hydride of the ring-opening polymer of a monomer having a norbornene structure, a hydride of the ring-opening copolymer of a monomer having a norbornene structure and a monomer capable of ring-opening copolymerizing with the monomer having a norbornene structure, a hydride of the addition polymer of a monomer having a norbornene structure, and a hydride of the addition copolymer of a monomer having a norbornene structure and a monomer capable of addition copolymerizing with the monomer having a norbornene structure is used as the polymer having an alicyclic structure, the hydrogenation method is not particularly limited, and the hydrogenation may be performed in accordance with a publicly known method. As an example of the hydrogenation method, a publicly known hydrogenation catalyst containing a transition metal such as nickel and palladium may be absorbed in a solution of the polymer, and contact with hydrogen may be performed. Since a higher hydrogenation rate usually tends to improve flowability and thermal resistance of the resulting hydride, it is preferable that the aforementioned hydrogenation is performed such that 90% or higher of carbon-carbon unsaturated bonds of the polymer is hydrogenated.

Among the aforementioned norbornene-based polymer, preferable is the one which has, as the repeating unit, X: bicyclo[3.3.0]octane-2,4-diyl-ethylene structure and Y: tricyclo[4.3.0.1^{2,5}]decane-7,9-diyl-ethylene structure, in which the content of these repeating units X and Y is not less than 90 wt % relative to the whole repeating units of a norbornene-based polymer, and the ratio of the X content and the Y content as the weight ratio X:Y is 100:0 to 40:60. By using such a polymer, it is possible to obtain an optical film which does not cause size change for a long period of time and has excellent optical properties.

As the polymer having an alicyclic structure, one species may be used alone, or two or more species thereof may be used in combination at any ratio.

The molecular weight of the polymer having an alicyclic structure is usually not less than 10,000, preferably not less than 15,000, and more preferably not less than 20,000, and is usually not more than 100,000, preferably not more than 80,000, more preferably not more than 50,000 as a weight mean molecular weight (Mw) in terms of polyisoprene or polystyrene measured by gel permeation chromatography using cyclohexane as a solvent (when the polymer resin is not dissolved in cyclohexane, toluene may be used). When the weight mean molecular weight Mw falls within such a range, mechanical strength and molding processability are highly balanced, thus being preferable.

If necessary, the resin that contains the polymer having an alicyclic structure may also contain an additional component other than the polymer having an alicyclic structure. Examples of the additional component may include additives such as antioxidants, thermal stabilizers, photostabilizers, ultraviolet radiation absorbers, antistatic agents, dispersing agents, chlorine scavenging agents, flame retardants, nucleating agents, toughening agents, blocking preventing agents, antifogging agents, mold release agents, pigments, organic or inorganic fillers, neutralizers, lubricants, decomposing agents, metal deactivators, fouling inhibitors, and antimicrobial agents; and a polymer that does not have an alicyclic structure. However, it is preferable that the amount of the additional component falls within a range in which the effect of the present invention is not significantly impaired. Specifically, the amount of the additional component relative to 100 parts by weight of the polymer having an alicyclic structure is usually not more than 50 parts by weight, and preferably not more than 30 parts by weight.

The glass transition temperature of the resin that contains the polymer having an alicyclic structure is usually not less than 130° C., preferably not less than 140° C., more preferably not less than 150° C. By setting the glass transition temperature to such a high temperature, the linear expansion coefficient of the substrate can be reduced in the temperature range of a usual high temperature environment in an image display device (not less than 30° C. and not more than 90° C.), and the linear expansion coefficient of the multilayer film of the present invention can also be reduced. The upper limit of the glass transition temperature of the resin that contains the polymer having an alicyclic structure is usually not more than 200° C., preferably not more than 180° C., and more preferably not more than 170° C. By setting the glass transition temperature in the aforementioned temperature range, a resin having suitable molding processability can be obtained.

Examples of the trade names of the aforementioned resin that contains the polymer having an alicyclic structure may include ZEONOR (manufactured by ZEON Corporation), Arton (manufactured by JSR Corporation), APEL (manufactured by Mitsui Chemicals, Inc.), and TOPAS (manufactured by Topas Advanced Polymers).

Usually, the substrate is a film-shaped member. The range of the specific thickness of the substrate is usually not thicker than 45 μm, preferably not thicker than 42 μm, and more preferably not thicker than 40 μm. When the thickness of the substrate is extremely thick, the linear expansion coefficient might not be effectively suppressed even with the cured resin layer. Therefore, the thickness of the substrate is set thin as described above. In order to give practical strength to the multilayer film of the present invention, the thickness of the substrate is usually not thinner than 10 μm, preferably not thinner than 20 μm, and more preferably not thinner than 25 μm.

In the multilayer film of the present invention, the ratio “T11/T10” of a substrate thickness T11 relative to a total thickness T10 of the substrate thickness and the cured resin layer thickness is not more than 0.95. Accordingly, the linear expansion coefficient of the multilayer film of the present invention can be effectively suppressed in the temperature range of not less than 30° C. and not more than 90° C. That is, in the multilayer film of the present invention, if the thickness ratio T11/T10 is set to a value that is not more than 0.95, the thermal expansion coefficient in the in-plane direction of the multilayer film can be significantly suppressed as compared to the case in which the thickness ratio T11/T10 is set to a value that is larger than 0.95. When the value of the aforementioned thickness ratio T11/T10 becomes smaller, the thickness of the cured resin layer becomes thicker. However, since efficient manufacture of a thick cured resin layer is difficult, the thickness ratio T11/T10 is usually not less than 0.6, preferably not less than 0.7, and more preferably not less than 0.8. When the multilayer film of the present invention has only one substrate layer, the thickness of the substrate means the thickness of that layer. When the multilayer film of the present invention has two or more substrate layers, the thickness means the total thickness of those layers. When the multilayer film of the present invention has only one cured resin layer, the thickness of the cured resin layer means the thicknesses of that layer. When the multilayer film of the present invention has two or more cured resin layers, the thickness means the total thickness of those layers.

The substrate is preferably an unstretched film which has not been stretched. When the substrate is a stretched film, difference in linear expansion coefficient may be caused between a stretched direction and a direction intersecting with the stretched direction. In particular, significant expansion or contraction tends to occur in a direction orthogonal to the stretched direction. Therefore, if the multilayer film of the present invention has a stretched film as the substrate, relatively significant deformation due to heat may occur in a direction in which the linear expansion coefficient is larger (usually, the direction orthogonal to the stretched direction). Even if an unstretched film is used as the substrate, difference in linear expansion coefficient may occur in the in-plane direction. However, the difference is smaller as compared to the case in which a stretched film is used as a substrate. Therefore, it is preferable that the substrate is an unstretched film for suppressing thermal expansion and preventing deformation. However, even if a stretched film is used as the substrate, the effect of suppressing a linear expansion coefficient can be obtained. Therefore, a stretched film may be used as the substrate depending on the application of the multilayer film of the present invention.

The substrate may have surfaces one or both of which is surface-treated. By performing the surface treatment, adhesion with other layers that are directly formed on the substrate can be improved. Examples of the surface treatment may include an energy ray irradiation treatment, and a chemical treatment.

Examples of the energy ray irradiation treatment may include a corona discharge treatment, a plasma treatment, an electron beam irradiation treatment, and an ultraviolet irradiation treatment. Among them, in view of treatment efficiency, the corona discharge treatment and the plasma treatment are preferable, and the corona discharge treatment is particularly preferable.

Examples of the chemical treatment may include performing immersion in an aqueous solution of an oxidizing agent such as a potassium bichromate solution or a concentrated sulfuric acid, and then performing sufficient washing with water. Shaking during immersion is effective.

However, immersion for a long period of time may cause dissolution of the film surface or deterioration in transparency. Therefore, it is preferable to adjust the treatment conditions such as immersion time and temperature depending on, e.g., reactivity and concentration of the chemicals used in the treatment.

Although the multilayer film of the present invention usually has only one substrate layer, the multilayer film may also have two or more substrate layers as long as the effect of the present invention is not impaired.

The method for producing the substrate is not limited. For example, the substrate may be produced by molding the resin that contains the polymer having an alicyclic structure by a publicly known film molding method. Examples of the film molding method may include a cast molding method, an extrusion method, and an inflation molding method. Among them, the melt extrusion method which does not use a solvent is preferable because that method can efficiently reduce the residual volatile matter content, and the method is thereby advantageous in view of global environment and working environment as well as manufacturing efficiency. Examples of the melt extrusion method may include an inflation method using a dice. A method using a T die is preferable in view of its excellent productivity and thickness precision.

[1-2. Cured Resin Layer]

The cured resin layer is a resin layer formed by curing by irradiation of an active energy ray. Therefore, as the resin that forms the cured resin layer, an active energy ray-curable resin is used. Usually, the cured resin layer is formed by forming a layer of a resin composition in an uncured state, and irradiating the layer with an active energy ray to effect curing.

(Resin Composition)

The resin composition in an uncured state contains one of monomers, oligomers, and polymers that are curable by irradiation with an active energy ray whereby polymerization reaction or cross-linking reaction proceeds. Any one of the monomers, oligomers, and polymers may be used as long as it is in an uncured state at a time prior to irradiation of an active energy ray. However, it is preferable that the resin composition contains one or both of the monomer and oligomer. This is because polymerization reaction or cross-linking reaction proceeding on the surface of the substrate brings about not only polymerization reaction or cross-linking reaction between the monomers or oligomers but also polymerization reaction or cross-linking reaction between the monomer or the oligomer and a reactive functional group present on the surface of the substrate, to thereby enable enhancement of adhesive strength between the substrate and the cured resin layer. Furthermore, by using the monomer or oligomer, surface hardness can be significantly improved, and abrasion resistance can be improved. The oligomer herein refers to a component in which two or more monomers are bonded and the polymerization degree is lower than a polymer. The weight mean molecular weight of the oligomer is usually not more than 10,000.

The monomer, oligomer, and polymer contained in the uncured state resin composition preferably have a polar group in view of improving adhesion with the substrate. In particular, the monomer, oligomer, and polymer which have many polar groups are more preferable. It is usually desirable that the multilayer film of the present invention do not have an in-plane phase difference. Therefore, it is preferable that the monomer, oligomer, and polymer contained in the uncured state resin composition also have low refractive index anisotropy and do not develop an in-plane phase difference in the cured resin layer.

Examples of the monomer, oligomer, and polymer contained in the uncured state resin composition may include polyester(meth)acrylate. Polyester(meth)acrylate may be obtained by, e.g., obtaining a polyester from a polybasic acid and a polyhydric alcohol and then effecting reaction at the terminal hydroxyl group thereof with (meth)acrylic acid.

Examples of the polybasic acid may include phthalic acid, adipic acid, maleic acid, itaconic acid, succinic acid, and terephthalic acid. As the polybasic acid, one species may be used alone, or two or more species thereof may be used in combination at any ratio.

Examples of the polyhydric alcohol may include ethylene glycol, 1,4-butanediol, 1,6-hexanediol, diethylene glycol, dipropylene glycol, polyethylene glycol, and polypropylene glycol. As the polyhydric alcohol, one species thereof may be used alone, or two or more species thereof may be used in combination at any ratio.

Specific examples of polyester(meth)acrylate may include Ebecryl 851, 852, 853, 884, 885 (manufactured by DAICEL-CYTEC Company LTD.); OLESTER (manufactured by Mitsui Chemicals, Inc.); and Aronix M-6100, M-6400, 6200, 6250, 6500 (manufactured by Toagosei Co., Ltd.).

Examples of the monomer, oligomer, and polymer contained in the uncured state resin composition may also include epoxy(meth)acrylate. Epoxy(meth)acrylate may be obtained as a reaction product that is prepared by ring-opening addition reaction of (meth)acrylic acid to an epoxy resin.

Examples of the epoxy resin may include bisphenol A type resin composed of bisphenol A and epichlorohydrin, novolak type resin composed of phenol novolak and epichlorohydrin, aliphatic type resin, and alicyclic type resin. Examples of the aliphatic-type epoxy resin for use may include ethylene glycol diglycidyl ether, tripropylene glycol diglycidyl ether, neopentyl glycol diglycidyl ether, 1,4-butanediol diglycidyl ether, 1,6-hexanediol diglycidyl ether, trimethylolpropane diglycidyl ether, and polyethylene glycol diglycidyl ether. Examples for use may also include an unsaturated fatty acid epoxy resin such as a butadiene-based epoxy resin and an isoprene-based epoxy resin. Examples of the alicyclic-type epoxy resin for use may include vinylcyclohexene monoxide, 1,2-epoxy-4-vinylcyclohexane, 1,2:8,9-diepoxylimonene, and 3,4-epoxycyclohexenylmethyl-3′,4′-epoxycyclohexenecarboxylate. As the epoxy resin, one species thereof may be used alone, or two or more species thereof may be used in combination at any ratio.

Specific examples of epoxy(meth)acrylate may include EBECRYL 600, 860, 3105, 3420, 3700, 3701, 3702, 3703, 3708, and 6040 (manufactured by DAICEL-CYTEC Company Ltd.); NEOPOL 8101, 8250, 8260, 8270, 8355, 8351, 8335, 8414, 8190, 8195, 8316, 8317, 8318, 8319, and 8371 (manufactured by Japan U-Pica Company, Ltd.); Denacol Acrylate DA212, 250, 314, 721, 722, and DM201 (manufactured by Nagase ChemteX Corporation); BANBEAM (manufactured by Harima Chemicals, Inc.); and Miramer PE210, PE230, and EA2280 (manufactured by Toyo Chemicals Co., Ltd.).

Examples of the monomer, oligomer, and polymer contained in the uncured state resin composition may also include urethane(meth)acrylate. Urethane(meth)acrylate may be obtained as a reaction product having a urethane backbone in the center thereof, by, e.g., reacting a (meth)acrylic monomer having a hydroxyl group, multifunctional isocyanate, and a polyhydric alcohol.

Examples of the (meth)acrylic monomer having a hydroxyl group may include 2-hydroxyethyl(meth)acrylate, hydroxypropyl(meth)acrylate, and hydroxybutyl(meth)acrylate. As the (meth)acrylic monomer having a hydroxyl group, one species thereof may be used alone, or two or more species thereof may be used in combination at any ratio.

Examples of multifunctional isocyanate may include tolylene diisocyanate, hexamethylene diisocyanate, tetramethylene diisocyanate, trimethylolpropane tolylene diisocyanate, and diphenylmethane triisocyanate. Among them, hexamethylene diisocyanate, which has good weather resistance, is suitably used. As the multifunctional isocyanate, one species thereof may be used alone, or two or more species thereof may be used in combination at any ratio.

As the polyhydric alcohol, those which may be used for polyester(meth)acrylate may be used.

Specific examples of urethane(meth)acrylate may include EBECRYL 204, 210, 220, 230, 270, 4858, 8200, 8201, 8402, 8804, 8807, 9260, and 9270, and KRM8098, 7735, and 8296 (manufactured by DAICEL-CYTEC Company Ltd.); UX2201, 2301, 3204, 3301, 4101, 6101, 7101, 8101, and 0937 (manufactured by Nippon Kayaku Co., Ltd.); UV 6640B, 6100B, 3700B, 3500BA, 3520TL, 3200B, 3000B, 3310B, 3210EA, 7000B, 6630B, 7461TE, and 7640B (manufactured by The Nippon Synthetic Chemical Industry Co., Ltd.); U-PICA 8921, 8932, 8940, 8936, 8937, 8980, 8975, and 8976 (manufactured by Japan U-Pica Company, Ltd.); and Miramer PU240, and PU340 (manufactured by Toyo Chemicals Co., Ltd.).

Further examples of the monomer, oligomer, and polymer contained in the uncured state resin composition may include acrylic acid-like compounds such as acrylic acid and methacrylic acid; acrylonitrile; methacrylonitrile; monofunctional acrylates or monofunctional methacrylates such as acrylate or methacrylate of ethylene oxide-modified phenol, acrylate or methacrylate of propylene oxide-modified phenol, acrylate or methacrylate of ethylene oxide-modified nonylphenol, acrylate or methacrylate of propylene oxide-modified nonylphenol, 2-ethylhexyl carbitol acrylate, 2-ethylhexyl carbitol methacrylate, isobornylacrylate, isobornylmethacrylate, tetrahydrofurfurylacrylate, tetrahydrofurfurylmethacrylate, hydroxyethylacrylate, hydroxyethylmethacrylate, hydroxypropyl acrylate, hydroxy propyl methacrylate, hydroxybutyl acrylate, hydroxybutyl methacrylate, hydroxyhexyl acrylate, hydroxyhexyl methacrylate, diethylene glycol monoacrylate, diethylene glycol methacrylate, dipropylene glycol monoacrylate, dipropylene glycol methacrylate, triethyleneglycol monoacrylate, triethylene glycol monomethacrylate, tripropylene glycol monoacrylate, tripropylene glycol monomethacrylate, methyl acrylate, methyl methacrylate, butyl acrylate, butyl methacrylate, 2-ethylhexyl acrylate, 2-ethylhexyl methacrylate, glycidyl acrylate, and glycidyl methacrylate;

multifunctional acrylates or multifunctional methacrylates such as diethylene glycol diacrylate, diethylene glycol dimethacrylate, triethyleneglycol diacrylate, triethylene glycol dimethacrylate, tetraethylene glycol diacrylate, tetraethylene glycol dimethacrylate, dipropylene glycol diacrylate, dipropylene glycol dimethacrylate, tripropylene glycol diacrylate, tripropylene glycol dimethacrylate, tetrapropylene glycol diacrylate, tetrapropylene glycol dimethacrylate, polypropylene glycol diacrylate, polypropylene glycol dimethacrylate, 1,4-butanediol diacrylate, 1,4-butanediol dimethacrylate, neopentyl glycol diacrylate, neopentyl glycol dimethacrylate, diacrylate or dimethacrylate of ethylene oxide-modified neopentyl glycol, diacrylate or dimethacrylate of ethylene oxide-modified bisphenol A, diacrylate or dimethacrylate of propylene oxide-modified bisphenol A, diacrylate or dimethacrylate of ethylene oxide-modified hydrogenated bisphenol A, diacrylate or dimethacrylate of trimethylolpropane, trimethylolpropane allyl ether diacrylate, trimethylolpropane allyl ether dimethacrylate, trimethylolpropane triacrylate, trimethylolpropane trimethacrylate, ethylene oxide-modified trimethylolpropane triacrylate, ethylene oxide-modified trimethylolpropane trimethacrylate, propylene oxide-modified trimethylolpropane triacrylate, propylene oxide-modified trimethylolpropane trimethacrylate, pentaerythritol triacrylate, pentaerythritol trimethacrylate, pentaerythritol tetraacrylate, pentaerythritol tetramethacrylate, dipentaerythritol hexaacrylate, and dipentaerythritol hexamethacrylate; and

2,2,6,6-tetramethyl-4-piperidinyl methacrylate and 1,2,2,6,6-pentamethyl-4-piperidinyl methacrylate having a cyclic hindered amine structure, and 2-(2′-hydroxy-5′-methacryloxyethylphenyl)-2H-benzotriazole having a benzotriazole ring.

One species of these may be used alone, or two or more species of these may be used in combination at any ratio.

Among the aforementioned monomers, oligomers and polymers, it is preferable that the uncured state resin composition contains (A) at least one type of oligomer-type acrylate selected from the group consisting of urethane acrylate, epoxy acrylate, and polyester acrylate. This is because thereby the thermal expansion coefficient of the multilayer film of the present invention can be stably suppressed, and adhesion with the resin that contains the polymer having an alicyclic structure can be maintained. Furthermore, among them, urethane acrylate and epoxy acrylate are more preferable, and urethane acrylate is particularly preferable.

The uncured state resin composition may contain a component other than the aforementioned monomer, oligomer, and polymer.

For example, it is preferable that the uncured state resin composition contains (B) inorganic particles having a number mean particle diameter of 100 nm or smaller. By containing such small inorganic particles, the cross-linking density of the cured resin layer can be enhanced without compromising transparency of the multilayer film of the present invention, and adhesion between the substrate and the cured resin layer can be enhanced. Furthermore, by containing inorganic particles, surface hardness can be enhanced. In particular, it is preferable to use the combination of (A) at least one type of oligomer-type acrylate selected from the group consisting of urethane acrylate, epoxy acrylate, and polyester acrylate, and (B) inorganic particles having a number mean particle diameter of 100 nm or smaller.

Examples of the material of the inorganic particles may include an oxide such as silicon oxide, magnesium oxide, zirconium oxide, and titanium oxide; and a fluoride such as magnesium fluoride, lithium fluoride, and sodium fluoride. Among them, an oxide is preferable, and silicon oxide (silica) is particularly preferable. As the inorganic particles, the one formed of one species of the materials may be used, or the one formed of two or more species of the materials may also be used. As the inorganic particles, one species of the inorganic particles may be used, or two or more species of the inorganic particles may be used in combination.

The number mean particle diameter of the inorganic particles is usually not larger than 100 nm and preferably not larger than 90 nm, and usually not smaller than 5 nm and preferably not smaller than 15 nm. With the inorganic particles having such a small number mean particle diameter, coating of the resin composition is facilitated. Although it is preferable that the particle size distribution of the inorganic particles is narrow and monodisperse, polydisperse particles may also be used. Therefore, as the inorganic particles, two or more types of particles which are different in number mean particle diameter may be used in combination. Furthermore, the inorganic particles may be aggregated particles as long as they satisfy the predetermined particle size. Although it is preferable that the shape of the inorganic particles is spherical, it may be an indefinite form. The number mean particle diameter may be measured from an electron microscopic photograph.

When the resin composition contains inorganic particles, the amount of the inorganic particles relative to a total weight of 100 parts by weight of the monomer, oligomer, and polymer is preferably not less than 5 parts by weight, more preferably not less than 10 parts by weight, and particularly preferably not less than 15 parts by weight, and preferably not more than 60 parts by weight, more preferably not more than 50 parts by weight, and particularly preferably not more than 40 parts by weight. By setting the amount of the inorganic particles within the aforementioned range, the effect of containing inorganic particles can be effectively exerted.

For example, the uncured state resin composition may contain a polymerization initiator. Examples of the polymerization initiator may include a photopolymerization initiator such as: an aryl ketone-based photopolymerization initiator (for example, acetophenones, benzophenones, alkylaminobenzophenones, benzyls, benzoins, benzoin ethers, benzyl dimethyl ketals, benzoyl benzoates, and α-acyloxim esters); a sulfur-containing photopolymerization initiator (for example, sulfides and thioxanthones); and an acylphosphine oxide-based photopolymerization initiator. As the polymerization initiator, one species thereof may be used alone, or two or more species thereof may be used in combination at any ratio. Also, the polymerization initiator may be used in combination with a photosensitizer such as amines.

The amount of the polymerization initiator relative to a total weight of 100 parts by weight of the monomer, oligomer, and polymer is preferably not less than 0.01 parts by weight and more preferably not less than 0.1 parts by weight, and preferably not more than 20 parts by weight and more preferably not more than 10 parts by weight.

For example, the uncured state resin composition may contain a solvent. Examples of the solvent may include ethers such as diacetone alcohol, propylene glycol monomethyl ether, and ethylene glycol monomethyl ether; alcohols such as isobutyl alcohol, isopropyl alcohol, n-butyl alcohol, and n-propyl alcohol; ketones such as acetone, methyl ethyl ketone, methyl isobutyl ketone, and acetylacetone; ethyl acetate, butyl acetate, xylene, and toluene. As the solvent, one species thereof may be used alone, or two or more species thereof may be used in combination at any ratio. The amount of the solvent may be appropriately adjusted depending on the coating conditions of the coating machine used (for example, proper viscosity and proper layer thickness).

For example, if necessary, the uncured state resin composition may contain an additive which the resin that forms the substrate may contain. However, it is preferable that the amount of the additive is set in a range that does not significantly impair the effect of the present invention. Specifically, the amount of the additive to a total amount of 100 parts by weight of the monomer, oligomer, and polymer is usually not more than 20 parts by weight, and preferably not more than 10 parts by weight.

(Coating Process)

After the preparation of the uncured state resin composition, a coating process is conducted in which a layer of the uncured state resin composition is formed on the surface of the substrate. The layer of the resin composition is formed on the surface of the substrate usually by a coating method. Examples of the coating method may include a spin coating method, a dipping method, a spraying method, a bar coating method, a die coating method, and a micro-gravure coating method.

(Heating Process)

If necessary, after the formation of the layer of the resin composition on the surface of the substrate, a heating process in which heat is applied to the layer is performed. By curing the layer of the resin composition by the two-step process of the heating process and the active energy ray irradiation process, the volatile matters such as a solvent can be readily removed, and adhesion between the substrate and the cured resin layer is enhanced to thereby further improve thermal expansion of the multilayer film of the present invention.

In the heating process, the temperature around the layer of the resin composition is set to preferably not less than 60° C. and more preferably not less than 80° C., and preferably not more than 150° C. and more preferably not more than 130° C. The heating time is usually one minute or more and within five minutes. The atmosphere during heating may be an oxidizing atmosphere in which oxygen such as air is present, or an inert gas atmosphere in which, e.g., nitrogen purge is performed.

Heating may be performed by a publicly known method using, e.g., a hot air oven, a near-infrared heater, a far-infrared heater, a carbon heater, or a heated roll. When the hot air oven is used, it is preferable to block the wind to the coated layer with, e.g., a baffle plate and a slit so that the jet of heated air does not directly blow the layer of the resin composition.

(Active Energy Ray Irradiation Process)

After the heating process has been performed as necessary, the layer of the resin composition is irradiated with an active energy ray. As the active energy ray, a variety of types of energy ray may be used depending on the type of the resin composition. Examples of such an energy ray may include an ultraviolet ray, a visible ray, and other electron rays. Among them, an ultraviolet ray is preferable.

Examples of the light source of the active energy ray may include a high-pressure mercury vapor lamp, and an electrodeless lamp.

The illuminance density of the active energy ray is preferably not less than 100 mW and more preferably not less than 200 mW, and preferably not more than 600 mW and more preferably not more than 500 mW. Also, irradiation amount of the active energy ray as an integrated light quantity is preferably not less than 300 mJ/cm² and more preferably not less than 400 mJ/cm², and preferably not more than 700 mJ/cm² and more preferably not more than 650 mJ/cm².

The atmosphere for the layer of the resin composition during irradiation of the active energy ray may be an oxidizing atmosphere in which oxygen such as air is present, or an inert gas atmosphere in which, e.g., nitrogen purge is performed.

By the irradiation of the active energy ray, the resin composition can be cured to obtain the cured resin layer.

(Composition, Thickness, Etc. Of Cured Resin Layer)

Since the cured resin layer is produced in the aforementioned manner, the cured resin layer contains a polymer obtained by the polymerization of the monomer, oligomer, and polymer contained in the uncured state resin composition, and the additional component such as inorganic particles which may be contained if necessary. Therefore, when the uncured state resin composition contains (A) at least one type of oligomer-type acrylate selected from the group consisting of urethane acrylate, epoxy acrylate, and polyester acrylate, and (B) inorganic particles having a number mean particle diameter of 100 nm or smaller, the cured resin layer contains the polymer obtained by the polymerization of the aforementioned oligomer-type acrylate, and the aforementioned inorganic particles. In the cured resin layer, the amount (parts by weight) of the inorganic particles relative to the polymers usually becomes the same as the amount thereof relative to the monomer, oligomer, and polymer in the uncured state resin composition.

The thickness of the cured resin layer may be arbitrary set as long as the ratio T11/T10 of the substrate thickness T11 relative to the total thickness T10 of the substrate thicknesses and the cured resin layer thickness falls within the aforementioned range. When the cured resin layer is provided on both the front surface and the back surface of the substrate, the thickness of two cured resin layers may be different. However, it is preferable that the thickness thereof is the same. This is for reliably preventing, e.g., warpage of the multilayer film of the present invention.

Although the cured resin layer may be provided on at least one surface of the substrate, it is preferable that the cured resin layer is provided on both surfaces of the substrate as shown in FIG. 1. This is for suppressing thermal expansion of the multilayer film of the present invention in more effective manner, and for reliably preventing, e.g., warpage of the multilayer film of the invention.

Although it is preferable that the cured resin layer is provided directly on the surface of the substrate, the cured resin layer may also be indirectly provided on the surface of the substrate via another layer, as long as the effect of the present invention is not significantly impaired. For example, the cured resin layer may be provided on the surface of the substrate via a thin adhesive layer having a thickness of 0.5 μm or thinner. However, in order to effectively exert the effect of the present invention, it is preferable that the cured resin layer is directly provided on the surface of the substrate.

Since the linear expansion coefficient of the cured resin layer after curing is small, even if the substrate is to causes thermal expansion due to temperature changes, the cured resin layer would restrain thermal expansion of the substrate in the in-plane direction. Therefore, the linear expansion coefficient of the multilayer film of the present invention as a whole can be suppressed.

(1-3. Physical Properties)

Since thermal expansion of the substrate is suppressed by the cured resin layer, the linear expansion coefficient of the multilayer film of the present invention is smaller than the linear expansion coefficient of the substrate. Specifically, when measured in the temperature range of from 30° C. to 90° C., the linear expansion coefficient of the multilayer film of the present invention is smaller than the linear expansion coefficient of the substrate by usually 5 ppm/° C. or more, preferably 8 ppm/° C. or more, and more preferably 10 ppm/° C. or more. The linear expansion coefficient of the multilayer film of the present invention herein refers to a linear expansion coefficient in the in-plane direction of the multilayer film, and the linear expansion coefficient of the substrate refers to a linear expansion coefficient in the in-plane direction of the substrate. Although the linear expansion coefficients in the in-plane directions are usually ununiform in the multilayer film of the present invention and in the substrate, the linear expansion coefficient of the multilayer film of the present invention may be smaller than the linear expansion coefficient of the substrate as described above in at least one direction of the in-plane directions. However, it is more preferable that the liner expansion coefficient of the multilayer film of the present invention is smaller than the linear expansion coefficient of the substrate as described above in all the in-plane directions.

The linear expansion coefficient is measured by cutting out the subject to be measured (e.g., a multilayer film, and a substrate) into a sample piece, firstly heating the sample piece at a heating rate of 20° C./minute from 25° C. to 120° C., then cooling down the sample piece, and then performing measurement while heating the sample piece at a heating rate of 10° C./minute from 25° C. to 120° C. Other than that, the measurement is performed in accordance with JIS K7197. From the results of the measurement, the linear expansion coefficient when heated from 30° C. to 90° C. may be calculated.

The moisture permeability of the multilayer film of the present invention is preferably not more than 500 g/m²-24 h, more preferably not more than 100 g/m²·24 h, and particularly preferably not more than 60 g/m²·24 h. In the multilayer film of the present invention, since the moisture permeability of the resin that contains a polymer having an alicyclic structure, which forms the substrate, tends to be low, the low moisture permeability as described above can be realized. The lower limit is preferably not less than 20 g/m²·24 h, more preferably not less than 30 g/m²·24 h, and particularly preferably not less than 40 g/m²·24 h. Specific value of the moisture permeability may be controlled by, e.g., adjusting the material and the thickness of the substrate and the cured resin layer. The moisture permeability may be measured under the conditions of 40° C. and 90% RH in accordance with JIS K7129B.

Since the multilayer film of the present invention is usually used as an optical film, it is preferable that the multilayer film has high transparency.

Specifically, the total light transmittance of the entire multilayer film is preferably not less than 85%, more preferably not less than 92%. The upper limit is ideally 100%. The total light transmittance may be measured in accordance with JIS K7361-1997.

Since the multilayer film of the present invention may be used as, e.g., a substrate film for a phase difference film, it is preferable that the haze thereof is small. Specifically, the haze of the entire multilayer film is usually not more than 10%, preferably not more than 5%, and more preferably not more than 1%. Although the lower limit is ideally zero, the lower limit is usually not less than 0.1%. The haze may be measured in accordance with JIS K7361-1997.

It is preferable that the multilayer film of the present invention has a hardness of HB or harder in terms of the JIS pencil hardness. The JIS pencil hardness thereof may be controlled by, e.g., adjusting the material and the thickness of the substrate and the cured resin layer. The JIS pencil hardness is determined by scratching the film surface with pencils in accordance with JIS K5600-5-4. Scratching is performed with pencils with a variety of hardness which are inclined at the angle of 45° to which 500 gram-force of downward load is applied. The hardness is determined as the softest pencil that creates scratches.

Furthermore, since usually the cured resin layer has high hardness, the multilayer film of the present invention is excellent in abrasion resistance. In particular, there is a tendency that the abrasion resistance is particularly excellent when the cured resin layer contains inorganic particles. For evaluating abrasion resistance, the surface of the multilayer film is rubbed in ten reciprocating moves with steel wool #0000 while the steel wool is pressed against the surface of the multilayer film at a load of 0.025 MPa. Then, the state of the rubbed surface of the multilayer film is visually observed. The observation may be evaluated in accordance with the following indices.

“Good”: No flaw is observed.

“Poor”: A flaw is observed.

(1-4. Others)

The multilayer film of the present invention may be provided with a layer other than the substrate and the cured resin layer, as long as the effect of the present invention is not significantly impaired. For example, a removable protective sheet may be provided on the surface of the multilayer film of the present invention. By providing the protective sheet, the multilayer film of the present invention can be protected from scratches when the multilayer film of the present invention is wound into a roll shape for preservation and transportation. Furthermore, the protective sheet may reduce the dynamic friction coefficient between the multilayer films when the multilayer film of the present invention is wound into a roll shape, so that a roll without wrinkle or band (a band-shaped convex portion which is formed as a result of partial protrusion of the film and extends in the circumferential direction of the roll) can be produced. Usually, the aforementioned protective sheet is to be removed from the multilayer film of the present invention when the multilayer film is used.

(2. Liquid Crystal Display Device)

The liquid crystal display device of the present invention includes a liquid crystal cell, a viewing-side polarizing plate provided at a position closer to the viewing side than the liquid crystal cell, and a multilayer film of the present invention provided at a position closer to the viewing side than the viewing-side polarizing plate. Although embodiments of the liquid crystal display device of the present invention will be explained hereinbelow with reference to the drawings, the liquid crystal display device of the present invention is not limited to the following embodiments.

### First Embodiment

FIG. 2 is a diagram schematically showing the structure of a three-dimensional image display device as a first embodiment of the liquid crystal display device of the present invention. In FIG. 2, the left side in the diagram is a light source side, and the right side in the diagram is a viewing side. As shown in FIG. 2, a three-dimensional image display device 100 has a light source 110, a liquid crystal panel 120, and a phase difference film laminate 130, in this order.

The light source 110 emits light that is used for image displaying. The liquid crystal panel 120 has, in the order from the closest to the light source 110, a light source-side polarizing plate 121 that is a linear polarizing plate, a liquid crystal cell 122, and a viewing-side polarizing plate 123 that is a linear polarizing plate. Therefore, light emitted from the light source 110 passes through the liquid crystal panel 120, and goes out of the viewing-side surface of the liquid crystal panel 120 as linearly polarized light.

The phase difference film laminate 130 has a substrate film 131, a first phase difference film 132, and a second phase difference film 133. As the substrate film 131, the multilayer film of the present invention is used. It is assumed that the substrate film 131 does not have an in-plane phase difference.

The first phase difference film 132 is a phase difference film which is formed directly or via an orientation film on the surface of the substrate 131. In the first phase difference film 132, regions having different phase differences exist in its plane in a patterned manner. The term “patterned manner” means being repeated in a constant cycle. That is, that the regions having different in-plane phase differences are “patterned” in a plane refers to that the regions having two or more different in-plane phase differences are arranged in the plane such that the regions repeatedly appear in the same order when observed along a certain direction in the plane. It is preferable that the patterned regions are in a stripe shape wherein the thin long belt-shaped regions are aligned in parallel. The regions having different phase differences may refer to an embodiment in which a plurality of regions having different phase difference values exist; and an embodiment in which the region having a phase difference and a region not having a phase difference exist.

In the present embodiment, the first phase difference film 132 has an anisotropic region 134 which gives the in-plane phase difference of an approximately ½ wavelength with respect to the transmitted light so as to function as a ½ wavelength plate, and an isotropic region 135 through which the incoming light passes without substantially changing the light polarization state thereof, wherein these regions are provided as belt-shaped regions in which the anisotropic region 134 and the isotropic region 135 are alternately located along a certain direction. Giving the in-plane phase difference of an approximately ½ wavelength with respect to the transmitted light herein means that the in-plane phase difference of the anisotropic region 134 for the light having a wavelength of 550 nm is usually ±65 nm, preferably ±30 nm, and more preferably ±10 nm from the value that is ½ of the center value of the wavelength range of the transmitted light. Without substantially changing the light polarization state means that, when the incoming polarized light is a linearly polarized light, the light passes therethrough as it is as linearly polarized light, and when the incoming polarized light is circularly polarized light, the light goes out as it is as circularly polarized light. In FIG. 2, the anisotropic region 134 is hatched in order to distinguish the anisotropic region 134 and the isotropic region 135.

The second phase difference film 133 is a phase difference film formed on the surface of the first phase difference film 132 directly or via, e.g., an orientation film, and has a uniform in-plane phase difference. Specifically, the in-plane phase difference of the second phase difference film 133 for the light having a wavelength of 550 nm is in a range of usually ±65 nm, preferably ±30 nm, and more preferably ±10 nm from the value that is ¼ of the center value of the wavelength range of the transmitted light, or is in a range of usually ±65 nm, preferably ±30 nm, and more preferably ±10 nm from the value that is ¾ of the center value thereof, so that the second phase difference film 133 can function as a ¼ wave plate.

The aforementioned in-plane phase difference Re is a value represented by (nx−ny)×d (wherein nx represents a refractive index in the direction that is perpendicular to the thickness direction (the in-plane direction) and gives the highest refractive index, ny represents a refractive index in the direction that is perpendicular to the thickness direction (the in-plane direction) and orthogonal to the nx direction, and d represents the film thickness). The phase difference Rth in the thickness direction is a value represented by {(nx+ny)/2−nz}×d (wherein nx represents a refractive index in the direction that is perpendicular to the thickness direction (the in-plane direction) and gives the highest refractive index, ny is a refractive index in the direction that is perpendicular to the thickness direction (the in-plane direction) and orthogonal to the nx direction, nz represents a refractive index in the thickness direction, and d represents the film thickness).

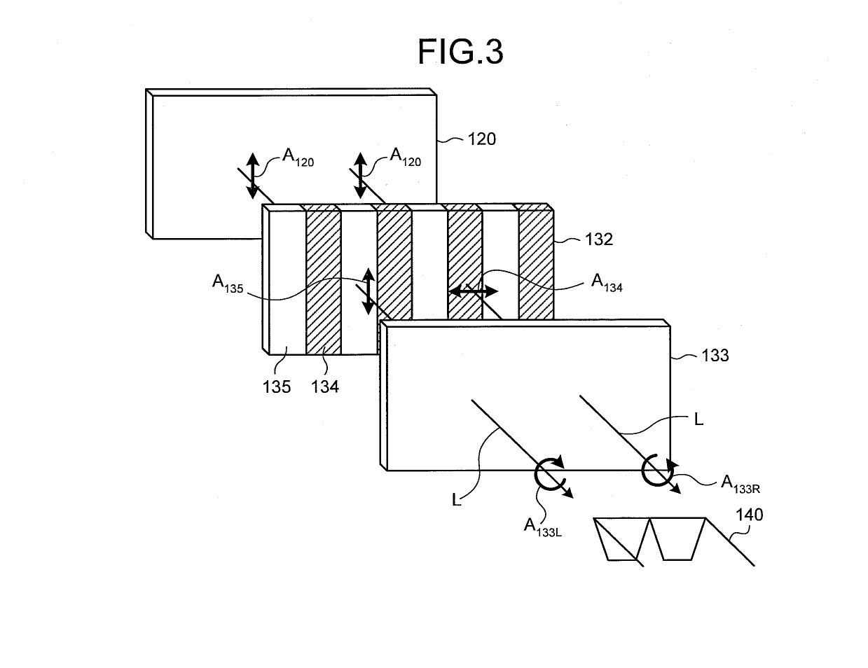

FIG. 3 is a perspective view schematically showing the liquid crystal panel 120, the first phase difference film 132, and the second phase difference film 133 of the disassembled three-dimensional image display device 100, in order to explain a mechanism of image displaying in the three-dimensional image display device 100 as the first embodiment of the liquid crystal display device of the present invention. In FIG. 3, the anisotropic region 134 is hatched in order to distinguish the anisotropic region 134 and the isotropic region 135.

Since the three-dimensional image display device 100 is configured as described above, as shown in FIG. 3, the light L which is emitted from the light source 110 (not shown in FIG. 3) passes through the liquid crystal panel 120, and goes out as linearly polarized light as shown by an arrow A₁₂₀.

The light L which has been transformed into linearly polarized light passes through the substrate film 131 (not shown in FIG. 3) and enters the first phase difference film 132. Of the light L that has entered the first phase difference film 132, the light L which has entered the anisotropic region 134 is given the phase difference of an approximately ½ wavelength when passing through the anisotropic region 134, thereby to goes out as linearly polarized light in which the polarization direction has been changed by 90° as shown by an arrow A₁₃₄. On the other hand, the light L that has entered the isotropic region 135 goes out as it is as linearly polarized light having the same polarization direction as that of the entering light as shown by an arrow A₁₃₅ without changing its polarization state.

The light L which has passed through the first phase difference film 132 enters the second phase difference film 133. The light L which has entered the second phase difference film 133 is given the phase difference of an approximately ¼ wavelength when passing through the second phase difference film 133, and goes out as circularly polarized light. Since the polarization directions of the light L which has passed through the anisotropic region 134 of the first phase difference film 132 and the light L which has passed through the isotropic region 135 are orthogonal to each other, the direction of the circularly polarized light of the light L which has passed through the anisotropic region 134 and then has passed through the second phase difference film 133, and the direction of the circularly polarized light of the light L which has passed through the isotropic region 135 and then has passed through the second phase difference film 133 are in a reverse direction, as shown by an arrow A_{133R} and an arrow A_{133L}.

The user of the three-dimensional image display device 100 views the light L which has come out of the second phase difference film 133 with wearing polarized glasses 140. The polarized glasses 140 are configured so that a right eye lens and a left eye lens are in a crossed Nichol state. The lenses of the polarized glasses 140 are configured such that the right eye lens transmits only one circularly polarized light of the right circularly polarized light and the left circularly polarized light, and the left eye lens transmits only the other circularly polarized light of the right circularly polarized light and the left circularly polarized light. Such polarized glasses 140 may be produced by, e.g., bonding a ¼ wave plate on a linear polarizing plate so that the slow axis of the ¼ wave plate forms an angle of 45° relative to the transmission axis of the linear polarizing plate. In this manner, the user views the light which has passed through one of the anisotropic region 134 and the isotropic region 135 with a right eye, and views the light which has passed through the other of the anisotropic region 134 and the isotropic region 135 with a left eye. In this manner, the user can visually recognize a three-dimensional image by displaying an image for a right eye and an image for a left eye.

In the present embodiment, since the multilayer film of the present invention is provided as the substrate film 131 of the phase difference film laminate 130 as shown in FIG. 2, even if the substrate film 131 is heated due to the heat emitted from the light source 110 or the temperature rise in the using environment, thermal expansion of the substrate film 131 is suppressed. This can prevent positional displacement of the anisotropic region 134 and the isotropic region 135 of the first phase difference film 132, and can also prevent refractive index change and deformation due to the stress on the first phase difference film 132. As a result, lowering of image quality can be prevented. In particular, since positional displacement of the anisotropic region 134 and the isotropic region 135 of the first phase difference film 132 may significantly lower the visibility of the three-dimensional image, suppression of the thermal expansion of the substrate film 131 in the three-dimensional image display device 100 is a significant advantage. In addition, the first phase difference film 132 and the second phase difference film 133 may be produced by coating and curing a liquid crystal composition. In such a case, the substrate film 131 becomes essential as a support of the cured liquid crystal composition layer. Therefore, thermal expansion of the substrate film 131 will significantly influence visibility of the three-dimensional image. However, if thermal expansion of the substrate film 131 can be suppressed, image quality can be prevented from lowering even in such a case. Therefore, the present embodiment is particularly preferable.

Although the first embodiment of the liquid crystal display device of the present invention has been hitherto described, the aforementioned embodiment may be further modified for implementation.

For example, the order of the first phase difference film 132 and the second phase difference film 133 may be swapped, so that the first phase difference film 132 is arranged at a position closer to the viewing side than the second phase difference film 133.

For example, the anisotropic region 134 in the first phase difference film 133 may be formed by, e.g., a twisted nematic liquid crystal, so as to be a region in which a linearly polarized light is optically rotated by 90°.

For example, the position of the substrate film 131 may be closer to the light source side than the first phase difference film 132 and the second phase difference film 133 as in the aforementioned embodiment, or closer to the viewing side than the first phase difference film 132 and the second phase difference film 133, or between the first phase difference film 132 and the second phase difference film 133.

For example, the three-dimensional image display device 100 may be provided with, e.g., a diffusion film, a brightness enhancing film, an adhesive layer, a sticky layer, a hard coat layer, an antireflective film, and a protective layer. The three-dimensional image display device 100 may be provided with, e.g., glass or plastic front surface plate on the viewing side of the phase difference film laminate 130.

### Second Embodiment

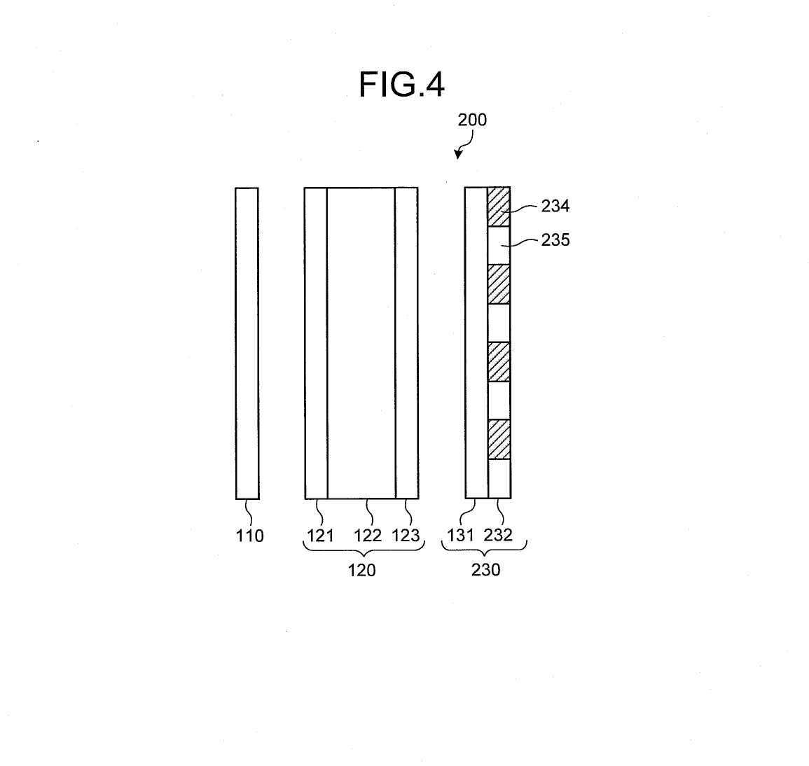

FIG. 4 is a diagram schematically showing a structure of a three-dimensional image display device as a second embodiment of the liquid crystal display device of the present invention. In FIG. 4, the left side in the diagram is the light source side, and the right side in the diagram is the viewing side. As shown in FIG. 4, a three-dimensional image display device 200 has a light source 110, a liquid crystal panel 120, and a phase difference film laminate 230, in this order.

In the three-dimensional image display device 200, the light source 110 and the liquid crystal panel 120 are the same as those of the first embodiment.

The phase difference film laminate 230 has a substrate film 131 and a phase difference film 232. The substrate film 131 is the same as that of the first embodiment.

The phase difference film 232 is a phase difference film formed directly or via, e.g., an orientation film on the surface of the substrate 131. In the phase difference film 232, regions in which the phase differences are the same but the directions of the slow axis are different exist in its plane in a patterned manner. The regions in which the phase differences are the same but the directions of the slow axis are different means an embodiment in which the phase differences are the same value but the directions of the slow axis in the regions are not in parallel.

In the present embodiment, the phase difference film 232 has a first anisotropic region 234 and a second anisotropic region 235, as belt-shaped regions in which the regions 234 and 235 are alternately located along a certain direction. The first anisotropic region 234 gives the in-plane phase difference of an approximately ¼ wavelength with respect to the transmitted light so as to function as a ¼ wave plate. The second anisotropic region 235 gives the same in-plane phase difference as that of the first anisotropic region 234 (that is, an approximately ¼ wavelength) with respect to the transmitted light, but has a different direction of the slow axis therefrom. The direction of the slow axis of the first anisotropic region 234 and the direction of the slow axis of the second anisotropic region 235 are different by 90°. Therefore, when certain linearly polarized light passes through the first anisotropic region 234 and the second anisotropic region 235, the direction of the circularly polarized light transformed by passing through the first anisotropic region 234, and the direction of the circularly polarized light transformed by passing through the second anisotropic region 235 are in a reverse direction. In FIG. 4, the first anisotropic region 234 is hatched in order to distinguish the first anisotropic region 234 and the second anisotropic region 235.

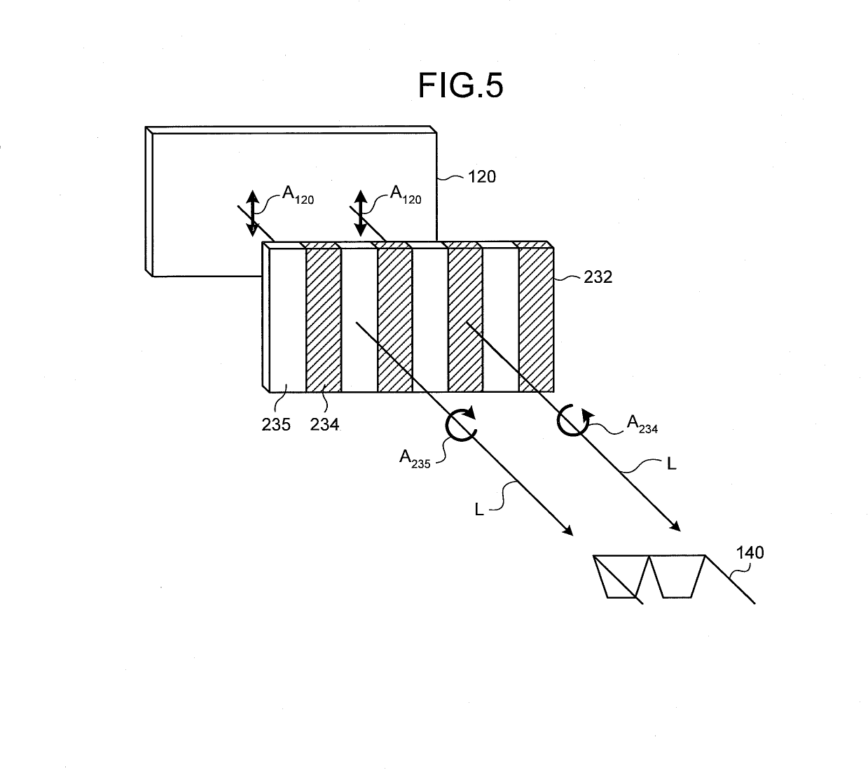

FIG. 5 is a perspective view schematically showing the liquid crystal panel 120 and the phase difference film 232 of a disassembled three-dimensional image display device 200, in order to explain a mechanism of image displaying in the three-dimensional image display device 200 as the second embodiment of the liquid crystal display device. In FIG. 5, the first anisotropic region 234 is hatched in order to distinguish the first anisotropic region 234 and the second anisotropic region 235.

Since the three-dimensional image display device 200 is configured as described above, as shown in FIG. 5, the light L which is emitted from the light source 110 (not shown in FIG. 5) passes through the liquid crystal panel 120, and goes out as linearly polarized light as shown by an arrow A₁₂₀.

The light L which has been transformed into linearly polarized light passes through the substrate film 131 (not shown in FIG. 5.) and enters the phase difference film 232. Of the light L that has entered the phase difference film 232, the light L which has entered the first anisotropic region 234 is given the phase difference of an approximately ¼ wavelength when passing through the first anisotropic region 234, and goes out as circularly polarized light. On the other hand, the light L that has entered the second anisotropic region 235 is also given the phase difference of an approximately ¼ wavelength when passing through the second anisotropic region 235, and goes out as circularly polarized light. However, since the directions of the slow axis of the first anisotropic region 234 and the second anisotropic region 235 are orthogonal to each other, the direction of the circularly polarized light transformed by passing through the first anisotropic region 234, and the direction of the circularly polarized light transformed by passing through the second anisotropic region 235 become in a reverse direction, as shown by an arrow A₂₃₄ and an arrow A₂₃₅.

The user of the three-dimensional image display device 200 views the light L which has come out of the phase difference film 232 with wearing polarized glasses 140. The polarized glasses 140 are configured so that a right eye lens and a left eye lens are in a crossed Nichol state in the similar manner to that of the first embodiment. The user thereby views the light which has passed through one of the first anisotropic region 234 and the second anisotropic region 235 with a right eye, and views the light which has passed through the other of the first anisotropic region 234 and the second anisotropic region 235 with a left eye. In this manner, the user can visually recognize a three-dimensional image by displaying an image for a right eye and an image for a left eye.

Also in the present embodiment, as shown in FIG. 4, since the multilayer film of the present invention is provided as the substrate film 131 of the phase difference film laminate 230, the advantage similar to that of the first embodiment can be obtained.

The present embodiment may be further modified for implementation. For example, the present embodiment may be modified in the same manner as in the first embodiment for implementation.

### EXAMPLES

Although the present invention will be specifically described with reference to the following Examples, the present invention shall not be limited to the following Examples, and can be arbitrary modified within the scope of the claims of the present invention and the equivalents thereof for implementation. In the following description, “part” and “%” for expressing amount are based on weight unless otherwise specified. Regarding temperature and pressure in the following description, unless otherwise specified, operation was conducted in the environment of ordinary temperature and pressure.

[Evaluation Method]

[Method for Thickness Measurement]

Using a contact thickness meter (manufactured by Mitutoyo Corporation, code No. 547-401), the film thickness was measured. Then, the film was severed, and the cross-sectional surface of the severed film was observed with an optical microscope to obtain the thickness ratio between each layer. From the ratio, thickness of each layer was calculated. The aforementioned operation was performed on 30 locations spaced apart by 50 mm intervals in the MD direction and the TD direction of the film, to obtain the mean value of the thickness. The obtained mean value was taken as the thickness of the film and the layer.

[Method for Measuring Difference in Linear Expansion Coefficient]

The linear expansion coefficient was measured by cutting out the subject to be measured (e.g., a multilayer film, and a substrate) into a sample piece, firstly heating the sample piece at a heating rate of 20° C./minute from 25° C. to 120° C., then cooling down the sample piece, and then performing measurement while heating the sample at a heating rate of 10° C./minute from 25° C. to 120° C. Other than that, the measurement was performed in accordance with JIS K7197. From the results of the measurement, the linear expansion coefficient when heated from 30° C. to 90° C. was calculated.

The linear expansion coefficient of the substrate was subtracted from the linear expansion coefficient of the multilayer film to calculate the difference in linear expansion coefficient between the multilayer film and the substrate.

The evaluations were performed in each of the MD direction and the TD direction of the film. The MD direction refers to the lengthwise direction of the substrate prepared as a lengthy film, and the TD direction refers to the crosswise direction of the substrate.

[Method for Measuring Moisture Permeability]

In accordance with JIS K7129B, the measurement was performed under the condition of 40° C./90% RH using “PERMATRAN W3/33” (manufactured by Mocon, Inc.).

[Pencil Hardness]

In accordance with JIS K5600-5-4, the film surface was scratched with pencils with a variety of hardness which were inclined at the angle of 45° to which 500 gram-force of downward load is applied. The hardness of the softest pencil that created scratches was taken as the pencil hardness.

[Abrasion Resistance]

The surface of the multilayer film is rubbed in ten reciprocating moves with steel wool #0000 while the steel wool is pressed against the surface of the multilayer film at a load of 0.025 MPa. The state of the rubbed surface of the multilayer film was visually observed. Then the observation was evaluated in accordance with the following indices.

“Good”: No flaw is observed.

“Poor”: A flaw is observed.

### Example 1

100 parts of urethane acrylate (manufactured by The Nippon Synthetic Chemical Industry Co., Ltd., trade name “UV7640B”), 30 parts of 4-hydroxybutyl acrylate (manufactured by Osaka Organic Chemical Industry Ltd., trade name “4HBA”), 10 parts of an organosilica sol (manufactured by Nissan Chemical Industries, Ltd., trade name “MEK-ST”, solid content 30%, a number mean particle diameter of 10 nm to 15 nm), 7.5 parts of a photopolymerization initiator (manufactured by Ciba Specialty Chemicals Corporation, trade name “Irg184”), and 412 parts of methyl isobutyl ketone as a solvent were mixed to prepare a resin composition in a liquid state.

ZEONOR Film (manufactured by ZEON Corporation, thickness 40 μm, glass transition temperature Tg of the material norbornene resin 163° C.) was prepared as a lengthy film-shaped substrate. Corona discharge treatment was performed on both surfaces of the substrate so as to have a wetting index of 56 dyne/cm.

Then, the prepared resin composition in a liquid state was applied onto one surface of the substrate using a bar coater #6. After dried at 70° C. for two minutes, irradiation at 200 mJ/cm² was performed with a high-pressure mercury vapor lamp to cure the resin composition. In this manner, the cured resin layer was formed.

Furthermore, the cured resin layer was also formed on the other surface of the substrate in the same manner.

Accordingly, a multilayer film provided having cured resin layers each having a thickness of 5 μm on both surfaces of the unstretched substrate having a thickness of 40 μm.

The obtained multilayer film was evaluated in accordance with the aforementioned procedures. The results are shown in Table 1.

### Example 2

A multilayer film was produced and evaluated in the same manner as in Example 1, except that the thickness of each cured resin layer on both surfaces is changed to 1.5 μm. The results are shown in Table 1.

### Example 3

A multilayer film was produced and evaluated in the same manner as in Example 1, except that ZEONOR Film having a thickness of 38 μm (the material thereof was the same as that in Example 1) was used as a substrate. The results are shown in Table 1.

### Example 4

A multilayer film was produced and evaluated in the same manner as in Example 1, except that the cured resin layer was provided on only one surface of the substrate. The results are shown in Table 1.

### Example 5

A multilayer film was produced and evaluated in the same manner as in Example 1, except that ZEONOR Film having a thickness of 23 μm (the material thereof was the same as that in Example 1) was used as a substrate. The results are shown in Table 1.

### Example 6

A multilayer film was produced and evaluated in the same manner as in Example 1, except that ZEONOR Film, in which the glass transition temperature Tg of the material norbornene resin was 135° C. (the thickness thereof was the same as in Example 1) was used as a substrate. The results are shown in Table 2.

### Example 7

A multilayer film was produced and evaluated in the same manner as in Example 1, except that epoxy acrylate EBECRYL600 (manufactured by DAICEL-CYTEC Company, Ltd.) was used in place of urethane acrylate UV7640B. The results are shown in Table 2.

### Example 8

A multilayer film was produced and evaluated in the same manner as in Example 1, except that MEK-ST-L (manufactured by Nissan Chemical Industries, Ltd., solid content 30%, a number mean particle diameter of 40 nm to 50 nm) was used in place of MEK-ST as the organosilica sol. The results are shown in Table 2.

### Example 9

A multilayer film was produced and evaluated in the same manner as in Example 1, except that ZEONOR Film after stretched by 1.5 times at a temperature of 170° C. in the MD direction was used as the substrate. The results are shown in Table 2. In this example, the thickness of the substrate became 38 μm due to stretching.

### Comparative Example 1

The substrate was used as it is as a sample, and evaluated in accordance with the aforementioned procedures. The results are shown in Table 3.

### Comparative Example 2

A multilayer film was produced and evaluated in the same manner as in Example 1, except that the conditions for applying the resin composition was changed, and the thickness of each cured resin layer on both surfaces was thereby changed to 0.8 μm. The results are shown in Table 3.

### Comparative Example 3

A multilayer film was produced and evaluated in the same manner as in Example 1, except that the conditions for applying the resin composition was changed, and the thickness of each cured resin layer on both surfaces was thereby changed to 0.4 μm. The results are shown in Table 3.

### Comparative Example 4

A multilayer film was produced and evaluated in the same manner as in Example 1, except that the conditions for applying the resin composition was changed, and the thickness of each cured resin layer on both surfaces was thereby changed to 15 μm. The results are shown in Table 3. In Comparative Example 4, since the cured resin layer was brittle and damaged, difference in linear expansion coefficient, pencil hardness, and abrasion resistance could not be evaluated.

TABLE 1
[Results of Examples 1 to 5]

| | | Ex. 1 | Ex. 2 | Ex. 3 | Ex. 4 | Ex. 5 |
|---|---|---|---|---|---|---|
| Substrate | Stretched or | No | No | No | No | No |
| | not | | | | | |
| | Thickness (μm) | 40 | 40 | 38 | 40 | 23 |
| | Glass | 163 | 163 | 163 | 163 | 163 |
| | transition | | | | | |
| | temperature | | | | | |
| | (° C.) | | | | | |
| Cured resin layer | Coated surface | Both | Both | Both | One | Both |
| | Oligomer type | UV7640B | UV7640B | UV7640B | UV7640B | UV7640B |
| | acrylate | | | | | |
| | Inorganic | MEK-ST | MEK-ST | MEK-ST | MEK-ST | MEK-ST |
| | particles | | | | | |
| | Thickness (μm) | 5.0 | 1.5 | 5.0 | 5.0 | 1.5 |
| Multilayer film | Thickness | 0.80 | 0.93 | 0.79 | 0.89 | 0.94 |
| | ratio | | | | | |
| | (substrate/(cu | | | | | |
| | red resin | | | | | |
| | layer + | | | | | |
| | substrate)) | | | | | |
| | Moisture | 45 | 45 | 45 | 45 | 45 |
| | permeability | | | | | |
| | (g/m² · 24 h) | | | | | |
| | Linear | 11.3 | 12.1 | 11.0 | 11.9 | 14.3 |
| | expansion | | | | | |
| | coefficient | | | | | |
| | difference in | | | | | |
| | MD direction | | | | | |
| | between | | | | | |
| | multilayer | | | | | |
| | film and | | | | | |
| | substrate | | | | | |
| | (ppm/° C.) | | | | | |
| | Linear | 11.0 | 11.1 | 10.2 | 11.2 | 12.5 |
| | expansion | | | | | |
| | coefficient | | | | | |
| | difference in | | | | | |
| | TD direction | | | | | |
| | between | | | | | |
| | multilayer | | | | | |
| | film and | | | | | |
| | substrate | | | | | |
| | (ppm/° C.) | | | | | |
| | Pencil | F | F | F | F | F |
| | hardness | | | | | |
| | Abrasion | Good | Good | Good | Good | Good |
| | resistance | | | | | |

TABLE 2
[Results of Examples 6 to 9]

| | | Ex. 6 | Ex. 7 | Ex. 8 | Ex. 9 |
|---|---|---|---|---|---|
| Substrate | Stretched or not | No | No | No | Lengthwise |
| | | | | | stretched |
| | Thickness (μm) | 40 | 40 | 40 | 38 |
| | Glass transition | 135 | 163 | 163 | 163 |
| | temperature (° C.) | | | | |
| Cured | Coated surface | Both | Both | Both | Both |
| resin | Oligomer type | UV7640B | EBECRYL600 | UV7640B | UV7640B |
| layer | acrylate | | | | |
| | Inorganic | MEK-ST | MEK-ST | MEK-ST-L | MEK-ST |
| | particles | | | | |
| | Thickness (μm) | 5.0 | 5.0 | 5.0 | 5.0 |
| Multi- | Thickness ratio | 0.80 | 0.80 | 0.80 | 0.79 |
| layer | (substrate/(cured | | | | |
| film | resin layer + | | | | |
| | substrate)) | | | | |
| | Moisture | 45 | 45 | 45 | 50 |
| | permeability | | | | |
| | (g/m² · 24 h) | | | | |
| | Linear expansion | 7.6 | 9.0 | 11.0 | 4.5 |
| | coefficient | | | | |
| | difference in MD | | | | |
| | direction between | | | | |
| | multilayer film | | | | |
| | and substrate | | | | |
| | (ppm/° C.) | | | | |
| | Linear expansion | 6.5 | 7.5 | 10.6 | 8.9 |
| | coefficient | | | | |
| | difference in TD | | | | |
| | direction between | | | | |
| | multilayer film | | | | |
| | and substrate | | | | |
| | (ppm/° C.) | | | | |
| | Pencil hardness | F | F | F | F |
| | Abrasion | Good | Good | Good | Good |
| | resistance | | | | |

TABLE 3
[Results of Comparative Examples 1 to 4]

| | | Comp. | Comp. | Comp. | Comp. |
|---|---|---|---|---|---|
| | | Ex. 1 | Ex. 2 | Ex. 3 | Ex. 4 |
| Substrate | Stretched or not | No | No | No | No |
| | Thickness (μm) | 40 | 40 | 40 | 40 |
| | Glass transition | 163 | 163 | 163 | 163 |
| | temperature (° C.) | | | | |
| Cured | Coated surface | — | Both | Both | Both |
| resin | Oligomer type | — | UV7640B | UV7640B | UV7640B |
| layer | acrylate | | | | |
| | Inorganic | — | MEK-ST | MEK-ST | MEK-ST |
| | particles | | | | |
| | Thickness (μm) | — | 0.8 | 0.4 | 15 |
| Multi- | Thickness ratio | — | 0.96 | 0.98 | 0.57 |
| layer | (substrate/(cured | | | | |
| film | resin layer + | | | | |
| | substrate)) | | | | |
| | Moisture | 45 | 45 | 45 | 45 |
| | permeability | | | | |
| | (g/m² · 24 h) | | | | |
| | Linear expansion | 0 | 4.3 | 2.3 | Not |
| | coefficient | | | | measurable |
| | difference in MD | | | | |
| | direction between | | | | |
| | multilayer film | | | | |
| | and substrate | | | | |
| | (ppm/° C.) | | | | |
| | Linear expansion | 0 | 4.5 | 3.5 | Not |
| | coefficient | | | | measurable |
| | difference in TD | | | | |
| | direction between | | | | |
| | multilayer film | | | | |
| | and substrate | | | | |
| | (ppm/° C.) | | | | |
| | Pencil hardness | 6B | F | F | Not |
| | | | | | measurable |
| | Abrasion | Poor | Good | Good | Not |
| | resistance | | | | measurable |

[Discussion on Examples 1 to 9 and Comparative Examples 1 to 4]

By comparing the aforementioned Examples and Comparative Examples, it was confirmed that provision of the cured resin layer that had been formed by curing by irradiation of an active energy ray on at least one surface of the substrate can suppress thermal expansion of the substrate, and that the linear expansion coefficient of a multilayer film can thereby be reduced. In these cases, as shown in the following Table 4, with the threshold at the ratio “0.95” of the substrate thickness relative to the total thickness of the substrate thickness and the cured resin layer thickness, the difference in linear expansion coefficient between the multilayer film and the substrate was significantly changed in both the MD direction and the TD direction. Therefore, it was confirmed that setting the aforementioned thickness ratio to be not more than 0.95 has critical significance.

TABLE 4
[Summary of results of Examples and
Comparative Examples wherein conditions other than
thickness were identical]

| | | | | | Comp. | Comp. |
|---|---|---|---|---|---|---|
| | Ex. 3 | Ex. 1 | Ex. 2 | Ex. 5 | Ex. 2 | Ex. 3 |
| Thickness of | 38 | 40 | 40 | 23 | 40 | 40 |
| substrate (μm) | | | | | | |
| Thickness of | 5.0 | 5.0 | 1.5 | 1.5 | 0.8 | 0.4 |
| cured resin layer | | | | | | |
| (per one surface) | | | | | | |
| (μm) | | | | | | |
| Thickness ratio | 0.79 | 0.80 | 0.93 | 0.94 | 0.96 | 0.98 |
| (substrate/(cured | | | | | | |
| resin layer + | | | | | | |
| substrate)) | | | | | | |
| Linear expansion | 11.0 | 11.3 | 12.1 | 14.3 | 4.3 | 2.3 |
| coefficient | | | | | | |
| difference in MD | | | | | | |
| direction between | | | | | | |
| multilayer film | | | | | | |
| and substrate | | | | | | |
| (ppm/° C.) | | | | | | |
| Linear expansion | 10.2 | 11.0 | 11.1 | 12.5 | 4.5 | 3.5 |
| coefficient | | | | | | |
| difference in TD | | | | | | |
| direction between | | | | | | |
| multilayer film | | | | | | |
| and substrate | | | | | | |
| (ppm/° C.) | | | | | | |

### Example 10

### Production and Evaluation of Image Display Device

(Production of Multilayer Film)

A multilayer film was produced in the same manner as in Example 2.

(Formation of Orientation Film on Multilayer Film)

A composition for an orientation film was prepared. The composition consisted of 100 parts of a modified polyamide (weight mean molecular weight of 45,000), 0.7 parts of p-toluenesulfonic acid, and 3,265 parts of 1-propanol. Corona discharge treatment was performed on one surface of the aforementioned multilayer film so as to have a wetting index of 56 dyne/cm. Then the prepared composition for an orientation film was applied thereonto using a bar coater #4, and dried at 100° C. for five minutes to obtain a dried film having a film thickness of 0.2 μm. Rubbing treatment was performed on the dried film to form the orientation film.

(Formation of First Phase Difference Film on Orientation Film)

40 parts of a polymerizable liquid crystal compound (LC242 manufactured by BASF Corporation), 2 parts of a polymerization initiator (manufactured by Ciba Specialty Chemicals Corporation, trade name “Irg907”), 0.04 parts of Futargent 209F (manufactured by Neos Company limited) as a surface active agent, and 60 parts of methyl ethyl ketone as a solvent were mixed to prepare a liquid crystal composition. The prepared liquid crystal composition was applied onto the surface of the aforementioned orientation film using a bar coater #8. Then, orientation treatment was performed at 75° C. for two minutes to effect orientation of the polymerizable liquid crystal compound.

A mask was prepared by applying, developing and etching a photoresist, and the mask was placed on the coated layer of the aforementioned liquid crystal composition. Through the mask, irradiation with weak ultraviolet light at 0.1 mJ/cm² to 45 mJ/cm² was performed from the coated layer side. The mask had stripe-shaped light shielding portions with a pitch of 150 μm. Accordingly, the polymerizable liquid crystal compound was cured in a region on which ultraviolet light irradiation was performed, to form a resin region having an in-plane phase difference of a ½ wavelength with respect to the transmitted light (an anisotropic region).

Subsequently, the mask was removed, and heating treatment was performed at 130° C. for 10 seconds, whereby the liquid crystalline phase of the liquid crystal composition in an uncured region of the coated layer was transformed into an isotropic phase. Keeping this state, irradiation with ultraviolet light at 2000 mJ/cm² was performed from the coated layer side under a nitrogen atmosphere so as to cure the isotropic phase region. Accordingly, a first phase difference film which has a dry film thickness of 2 μm and which has an anisotropic region giving in-plane phase difference of a ½ wavelength with respect to the transmitted light and an isotropic region substantially not changing the polarization state of the transmitted light on the same plane was thus prepared. The first phase difference film had a stripe-shaped pattern consisting of an anisotropic region and an isotropic region in conformity with the stripe shape of the light shielding portions of the used mask. The position of this pattern is configured to match the pixel position of the 3D liquid crystal monitor which will be described later.

(Formation of Orientation Film on First Phase Difference Film)

An orientation film was formed on the first phase difference film in the same manner as in the process for forming the orientation film on the multilayer film.

(Formation of Second Phase Difference Film on Orientation Film)

The liquid crystal composition that is the same as that prepared in the section “(Formation of first phase difference film on orientation film)” was applied onto the orientation film using a bar coater #4. Then orientation treatment was performed at 75° C. for two minutes. Furthermore, irradiation with ultraviolet light at 2000 mJ/cm² was performed from the coated surface side under a nitrogen atmosphere for effecting curing, to thereby form the second phase difference film having an in-plane phase difference of a ¼ wavelength with respect to the transmitted light.

Accordingly, a phase difference film laminate having the multilayer film, the orientation film, the first phase difference film, the orientation film, and the second phase difference film in this order was thus obtained.

(Implementation Evaluation)

A sheet which was bonded to the viewing-side polarizing plate of a 3D liquid crystal monitor “GD463D10” manufactured by Victor Company of Japan, Limited was peeled off. On the other hand, the surface of the phase difference film laminate on the cured resin layer side was subjected to corona discharge treatment so as to have a wetting index 56 dyne/cm. Position alignment of the surface of the phase difference film laminate on which corona discharge treatment had been performed, and the viewing-side polarizing plate of the 3D liquid crystal monitor from which the sheet had been peeled was performed while observing them in the transmitted light through a circle polarizing plate so that the pixel position of the 3D liquid crystal monitor and the stripe position of the phase difference film laminate were matched. Then, the viewing-side polarizing plate and the first phase difference film were bonded via a sticky layer.

The circle polarizing plate had a structure in which a ¼ wave plate was bonded to a linear polarizing plate.

The 3D liquid crystal monitor was left stand in an environment of 45° C. and 90% RH for 24 hours, and then returned to the room temperature for observation. In the observation, it was confirmed that warpage of the liquid crystal cell did not occur, and that the pixel position of the liquid crystal cell and the pattern position of the first phase difference film were remained unchanged in a matched state.

The 3D liquid crystal monitor was also left stand in an environment of 60° C. for 24 hours, and then returned to the room temperature for observation. In the observation, it was confirmed that warpage of the liquid crystal cell did not occur, and that the pixel position of the liquid crystal cell and the pattern position of the first phase difference film were remained unchanged in a matched state.

### INDUSTRIAL APPLICABILITY

The multilayer film of the present invention is preferably used as an optical film. Especially, in view of effective utilization of its low thermal expansion property, the multilayer film is particularly preferably used as an substrate film of an optical film used in an environment with temperature changes. Specific examples thereof may include a substrate film for a phase difference film in a three-dimensional image display device.

The liquid crystal display device of the present invention is suitably used as, for instance, a three-dimensional image display device such as a three-dimensional television.

### DESCRIPTION OF NUMERALS

10 Multilayer film
11 Substrate
12 Cured resin layer (resin layer formed by curing by irradiation of active energy ray)
100 Three-dimensional image display device (liquid crystal display device)
110 Light source
120 Liquid crystal panel
121 Light source-side polarizing plate
122 Liquid crystal cell
123 Viewing-side polarizing plate
130 Phase difference film laminate
131 Substrate film
132 First phase difference film
133 Second phase difference film
134 Anisotropic region
135 Isotropic region
140 Polarized glasses

1. A multilayer film comprising: a substrate consisting of a resin that contains a polymer having an alicyclic structure, the substrate having a thickness of not more than 45 μm; and a resin layer provided on at least one surface of the substrate, the resin layer being formed by curing by irradiation of an active energy ray, wherein:
a ratio of the substrate thickness relative to the total of the substrate thickness and the resin thickness is not less than 0.6 and not more than 0.95, and
in a temperature range of not less than 30° C. and not more than 90° C., a linear expansion coefficient of the multilayer film is smaller than a linear expansion coefficient of the substrate by 5 ppm/° C. or more.

2. The multilayer film according to claim 1, wherein a glass transition temperature of the resin that contains the polymer having the alicyclic structure is not less than 130° C.

3. The multilayer film according to claim 1, wherein a moisture permeability of the multilayer film is not less than 20 g/m²·24 h and not more than 500 g/m²·24 h.

4. The multilayer film according to claim 1, wherein the resin layer formed by curing by irradiation of an active energy ray is a resin layer formed by curing a composition containing at least a component (A) and a component (B), wherein:
the component (A) is at least one type of oligomer-type acrylate selected from the group consisting of urethane acrylate, epoxy acrylate, and polyester acrylate, and
the component (B) is inorganic particles having a number mean particle diameter of 100 nm or less.

5. A liquid crystal display device comprising a liquid crystal cell, a viewing-side polarizing plate provided at a position closer to a viewing side than the liquid crystal cell, and the multilayer film according to claim 1 provided at a position closer to a viewing side than the viewing-side polarizing plate.
